(19) United States
(12) Patent Application Publication
(10) Pub. No.: US 2009/0102973 A1
(43) Pub. Date: Apr. 23, 2009

(54) Video split device

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 10/754,120

(22) Filed: Jan. 9, 2004

(51) Int. Cl. H04N 5/45

(52) U.S. Cl. 348/565; 348/E05.112

(57) ABSTRACT

Video is adaptively allocated between different screen parts depending on its content. The content of the video is analyzed, and a determination is main about whether the video should be displayed in a large part of the screen or a smaller part of the screen. The screen split can be adaptively displayed, or the position where the video is display can be changed.

### BACKGROUND

Attempts to identify different kinds of content in video, specifically broadcast TV, are well-known. Many of these attempts correlate over the video in order to identify portions of the video which are likely to represent commercials. So-called replayTV units, available from Sonic Blue Inc., form a digital VCR which digitizes the incoming television and records it on a hard drive. The digital VCR records the signal, forms some kind of index that has information for use in locating the commercials, and during playback, automatically skips these commercials.

In addition, modern computers and computing devices often have the capability of displaying multiple windows of different information. Television sets often have a picture in picture function which allows a user to watch multiple items at the same time. However, such systems often do not have an organized way of determining what content to put in what picture.

### SUMMARY

The present invention teaches a system in which the user controls various aspects of the video identification and playback in order to identify and later skip desired selections. The identification unit may be totally separate from the device that actually does the recording. In addition, a preferred operation is responsive to user input to form specified signatures representing the undesired video. Since the user selects which parts of the video are undesired, the user has control over which parts of the video may be automatically skipped. The identification unit may index the recording by analyzing the recording to determine likely commercials. Different embodiments of this system are disclosed.

### BRIEF DESCRIPTION OF THE DRAWINGS

These and other aspects will now be described in detail with reference to the accompanying drawings, wherein:

FIG. 1 shows a first embodiment in which a special identification unit is used to analyze video content and skip over portions of the video content based on user-identified criteria.

FIG. 2 shows a second embodiment in which a remote control is suitably programmed to carry out the analysis and make determinations of suitable content for skipping.

### DETAILED DESCRIPTION

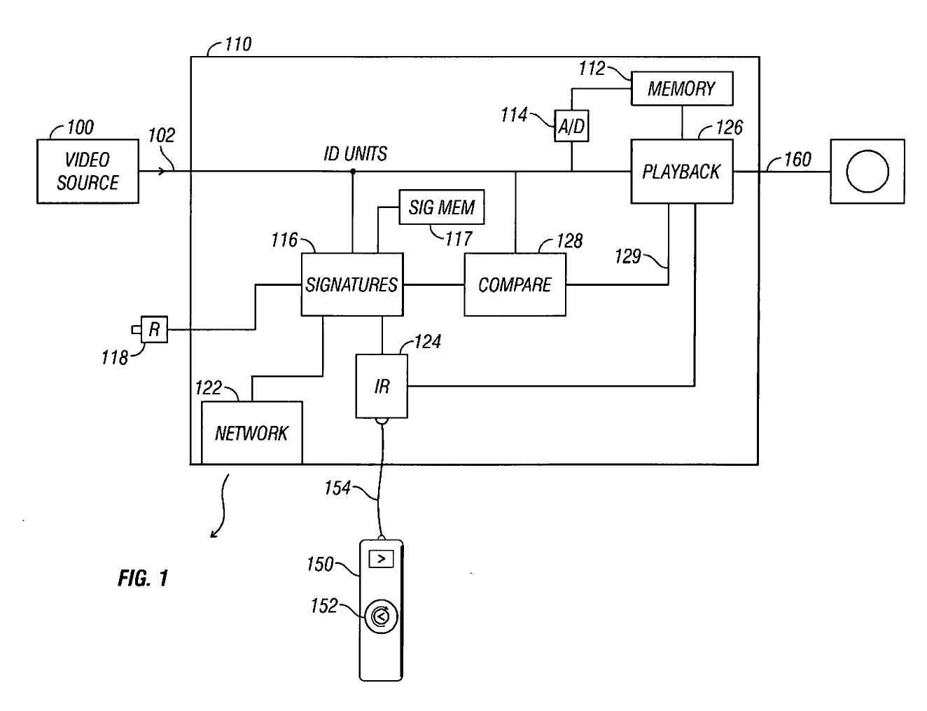

FIG. 1 shows a video source 100 which produces output video 102. Depending on the configuration of the device, the video 102 may be analog or digital signals. The video source may be a conventional source of broadcast video such as a television tuner, or a cable or digital cable line, satellite receiver, or the like. Video source may also be a digital tape recorder such as a replay TV type unit or TIVO, or ultimate TV type unit. The video signal 102 is input into the ID unit 110. ID unit 110 has an internal memory 112 which stores some portion of the incoming video. In one specific embodiment, the memory may be for example 1 GB of memory, in either a miniature hard drive or in random access memory, capable of storing approximately one half hour of playback video. Of course, the memory may be larger as desired. However, storage of one half hour of video will enable most desired commercial skipping operations.

The incoming video is coupled to the memory 112 and an A/D converter unit 114 may optionally be provided to digitize the signal in the case of an analog input. When signal is applied to the A/D unit, it immediately begins recording.

The ID unit also includes a signature memory 116 which may be a nonvolatile memory that stores signatures indicative of known undesired video segments. The signature may be very simple for example may be average luminance of the undesired video, or may be much more complex. Any type of signature which is known in the art to represent video or video segments can be used. One simplistic signature may be average luminance. Another is described in U.S. Pat. No. 5,581,658. Other signatures can alternatively be used; any signature that characterizes the video signal. According to an embodiment disclosed herein, a special signature is recorded which may be advantageous in analyzing the content of a commercial, although other signatures of sex scenes, violence scenes and the like may alternatively be provided.

The signatures in the signature store 116 may be changed as desired. Signature store 116 is shown connected to a network connection 122 which enables the signatures in the unit to be updated via network. This may be part of a subscription service or a free service on the Internet that identifies known commercials and/or undesired video. For example, this may be used to identify sex scenes and/or violence scenes in known videos, to allow skipping over those scenes. When used in this way, this system may be used to edit out certain scenes during playback.

Another and more preferred way of storing the signatures is by having the user identify the undesired video. A special remote control 150 is provided for use with the device 110. The remote control 150 includes a undesired video identifying (“UVI”) button at 152. When depressed, the undesired video button 152 sends a signal 154 to a corresponding infrared receiver of conventional type 124, located within unit 110. Preferably, the user holds down the UVI button 124 for the entire duration of the undesired scene. During the time that the UVI button is being depressed, the unit does two things: first it sends a signal to the signature unit 116 indicating that the incoming video represents undesired video. This incoming video is then stored for later processing to form a signature indicative of that undesired video. In addition, the unit may send a signal to the playback unit 126 which controls playback of the stored information from memory 112. This causes the playback unit to either skip a specified period (e.g. 30 seconds), or play the video at faster speed, for example at a double-speed or quadruple speed as conventional. Therefore, the user sees the video at faster-then-usual speed and at the same time marks it as being an undesirable part of the video.

In an alternative embodiment, only the beginning of the undesired portion is marked by pressing the UV button 152 only one time, right at the beginning of the undesired portion. The signature formation unit 117 then automatically identifies the end of the current scene (or commercial) and automatically forms a signature.

As described above, this system may be used for skipping many kinds of video content. In addition, alternative ways may be used for identifying the commercials. For example, a single depression of the commercial button may be used to identify a commercial break, and video processing techniques may be used to determine the end of the commercial break or the end of the scene being viewed. For example, when there is a change in the luminance of the scene by more than 10%, this may signify that the end of the scene is being viewed.

An advantage of this system is that the user forms and stores their own signatures. The user can select what parts of the video to be watched and other parts that are not being watched. If the user desires to see some commercials or other video, the user can see those. Alternatively, however, the user can skip other commercials by entering signatures into the unit 116. In addition, the signature unit may include a reset button 118 which may be used in order to clear the signature store and start over.

However formed, video 102 is compared with the signatures in store 118 by a comparison unit 128. The comparison unit compares the incoming video with the signatures and produces an output signal 129 which may indicate “skip during play”. The output signal 129 controls the playback unit 126. Therefore, if the comparison unit 128 detects a 25 second commercial, it may produce a digital signal at 129 which tells the playback unit to skip forward by 25 seconds.

In operation, a video source is applied, and automatically fills the memory 112 with video. When the user wants to watch that video, preferably at least about a half hour's worth of video storage, or after some certain segment of video has been entered into the playback unit 126, the user selects play on the remote control, causing the playback unit to read from the memory 112 and thereby produce the output video signal 160. During the playback, the video is continually compared with the signatures in unit 116 by comparison unit 128. Any match causes this portion of the playback which is currently identified to be automatically skipped.

Since the user sets the signatures, use of the unit may be less likely to be considered a copyright infringement. In addition, since the ID unit 110 is separate from any recording part, it can be used with many different video sources.

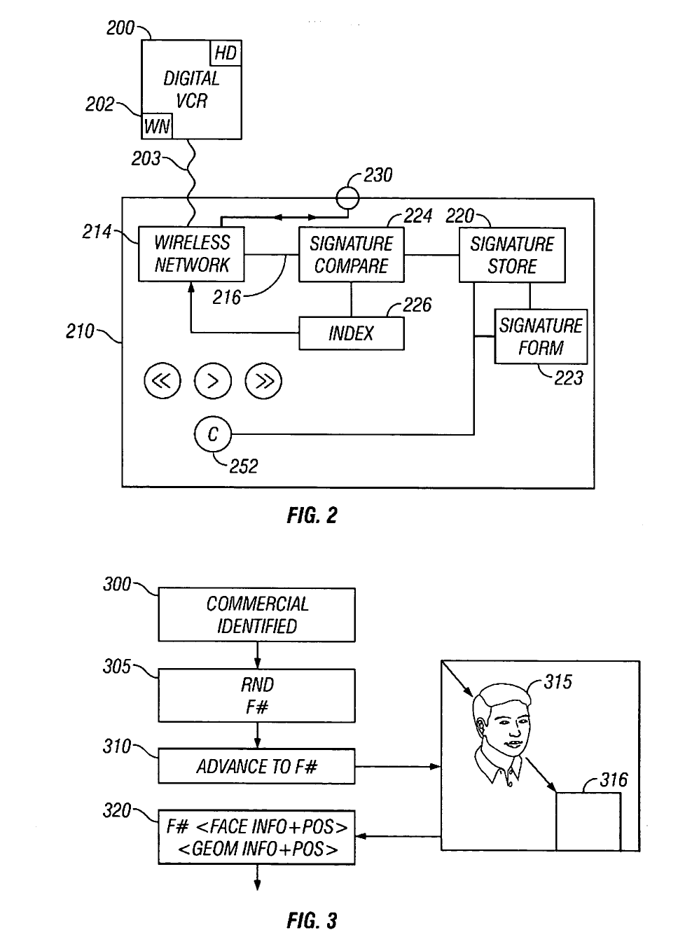

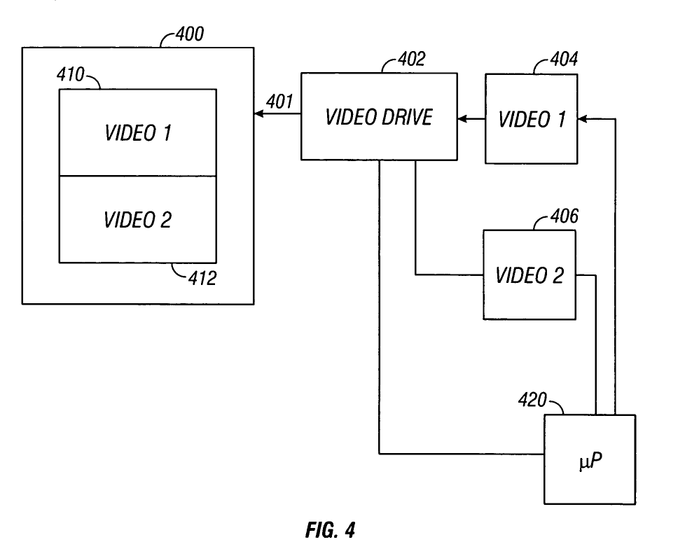

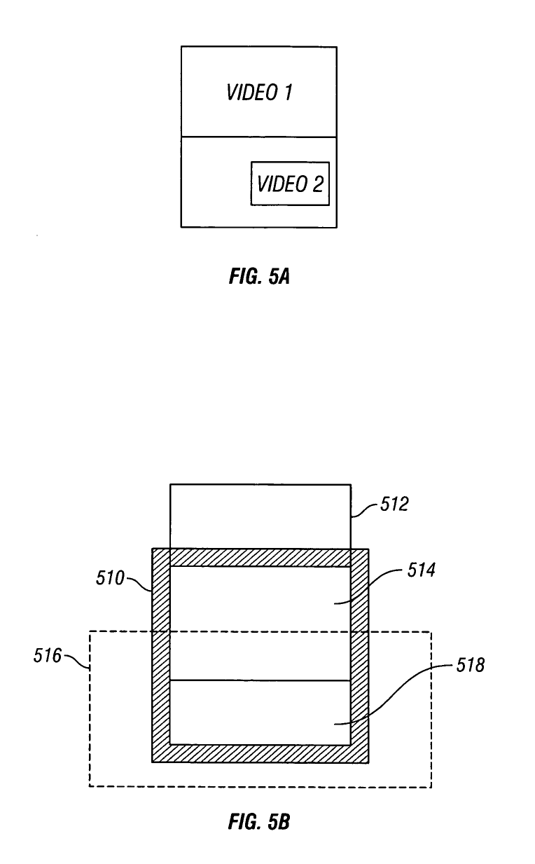

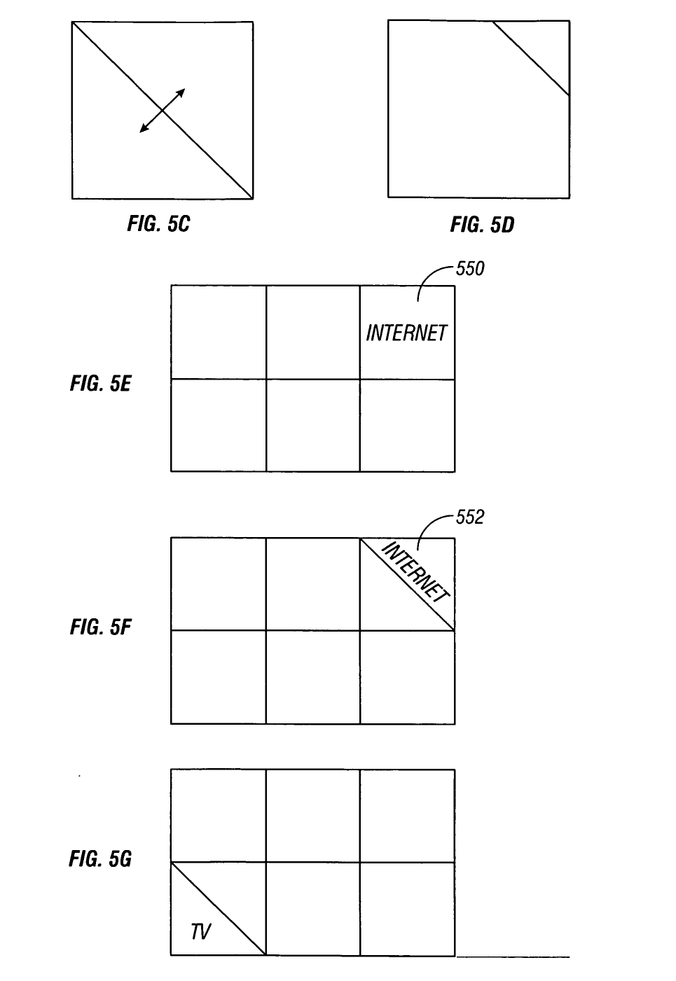

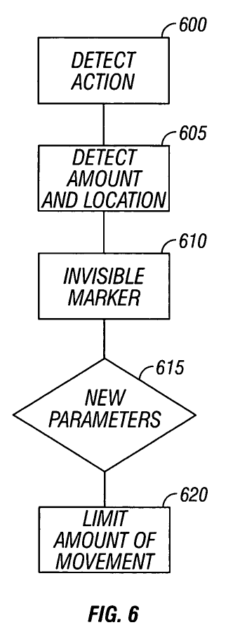

FIG. 2 shows an alternative embodiment in which the undesired video skipping operation is carried out in a remote control unit which interfaces with a digital VCR 200 such as TIVO, TV replay type unit or the like. In this embodiment, both a digital VCR 200, and the remote control 210 include wireless network capabilities, which can be wireless ethernet such as 802.11a or 802.11b network, a Bluetooth network, or any other type of wireless network command. Digital video recorder (“VR”), 200 includes a wireless network unit 202. Remote control 210 includes a wireless network part 214 which communicates with the corresponding network unit 202 in digital VR 200.

In operation, the remote control 210 includes conventional buttons such as play, fast forward and stop. Remote control 210 also includes a special commercial button 252. This button is depressed to identify a commercial. During playback, digital VR sends information indicative of advanced video which will be played from the hard drive 204 within the digital VR over the wireless network 203 to the remote control. Therefore, the remote control receives information indicative of the video which will be played in the future. In one embodiment, this may be a reduced resolution version of the video, since it will only be used for analyzing signatures. In this embodiment, the signature storage unit 220 is located in the remote control. The video which is received 216 is compared with the signatures in the signature storage unit by comparison device 224. This comparison produces an index 226 which is used to drive the playback. In this embodiment, the control of the digital VR is shown as being carried out over the wireless network, although an infrared control may also be used. For example, if the signature comparer 224 indicates that an undesired video clip is playing, at some future time, an entry in the index unit 226 is made indicating the time. This entry is used to tell that the digital VR to skip over the time that the commercial or undesired video. As in the embodiment of FIG. 1, the UVI button 252 is used to form a signature using the signature forming unit 223 to analyze the incoming video and to store the signature in the signature storage unit 220. Again, this enables skipping any type of undesired video and is not limited to commercials although it may be used for commercials.

As noted above, any conventional method known in the art for forming signatures may be used for identifying the undesired portions of video. Any signal that characterizes the video may be used as a signal. However, one specifically advantageous system is shown herein. This may be used, for example, by a processor that is processing the video stream. At 300, an UV segment is identified. A random number generator, which may be a software function is then used to generate a frame number. The video is advanced by this frame number to investigate another frame which is then analyzed. Most commercials will include a picture of a person within the commercial. The frame is analyzed from left corner downward to look for a picture of person's face which is identified as face 315. Digital information indicative of the face is stored along with additional information about the face. After storing that face information, the system continues correlating down from the left corner looking for a geometric object of relatively consistent color. The geometric object 316 is found, and information indicative of the geometric object (e.g., it is a of specified size, for example), is stored along with its position. This forms a signature at 320 which includes the frame number, face information and position, and geometric information and position.

An advantage of this signature is that conventional face recognition software may then be used to analyze the incoming video stream to recognize the face. This face recognition software may operate relatively quickly, and is an established technology. In addition, the geometric information may use techniques which are known in video rendering.

This embodiment may be used to identify any biometric part, using biometric identification techniques.

Since the frame number is known, and the number of frames per second in video are known (typically 30 frames per second interleaved), this can be used to identify the beginning point of the commercial. The end point of the commercial may also be identified using conventional techniques.

The above has discussed identification of undesired video segments such as commercials, and the possibility of skipping over or moving quickly over these commercials. However, there are other things that can be done with commercials besides skipping over them. An embodiment, which may form one application of the commercial or undesired video skipping, is shown below. In this embodiment, multiple applications may be running simultaneously on one or many screens. While the embodiment shows the applications running on a single screen, it should be understood that this can also apply to multiple screens, in much the same way.

The screen shown as 400, is driven by a video driver 402. The video driver can be driven by any type of video source for which can include a computer, or a prerecorded video player, or any combination of these things, and the video driver itself can be a video card, or a software driver, or any other item which can form video. A second video source 406 is also shown, but it should be understood that two separate video sources can be integrated into the same physical unit. For example, one video source may be an interactive video element such as a computer game or the Internet. The other video source may be a commercial tv program, or other type of television program. Both video sources are sent to the video driver which formats the video signal. The video signal in this embodiment is split between a top video shown as video 1 element 410 and a bottom video shown as video 2, element 412. One or both of the video units may be controlled by a processor shown as 420, and the processor may also control the video driver to assign percentage of split on the screen 404. For example, the processor may control the amount of space that video 1 takes relative to video 2. FIG. 5A shows one possible alternative where video one takes approximately two thirds of the screen, and video two takes approximately one third. In this embodiment, the aspect ratio is kept more or less constant between the two video portions. Alternatively, the video may be truncated so that the video effectively takes an adaptive part of the screen.

FIG. 5B shows how a four by three video may be truncated down to something less than its entire aspect. For example, FIG. 5B shows the frame representing the screen as 510. Video one is represented by 512, but only a portion 514 of that video 512 is actually shown within the screen. Similarly, a second video shown as 516, is larger than the portion of the screen 518 which can display the video. In this embodiment, both the split between sizes of the video shown, and the portion of the video shown (when that video is truncated) are adaptively selected.

The processor 420 runs a program which is shown in flowchart form in FIG. 6. The flowchart runs a set of rules, which may be set by the user or may be set at the default values. According to the default rules, if one video portion has action, and the other video portion does not have action, then the screens are split with the action part getting ⅔ of the screen, and the non-action part getting ⅓. If both or neither have action, then the split is set to 50-50. However, to avoid distracting the user, the split between different percentages is carried out relatively slowly. When action occurs, in one screen or the other screen, it tends to cause the split between displayed parts to start changing slowly. The part with more action is assigned larger percentage of the screen which slowly increases.

Some exceptions to this general rule may be noted. For example, a quick change in split size may be carried out in response to certain stimuli. For example, a quick split size change may occur when the user actually takes physical actions such as clicking on an item in the Internet, or playing a game or a part of the game. Another stimulus which could change the split size quickly is detection of undesired video such as a commercial.

The basic operation in FIG. 6 starts by detecting an action which is shown as 600. The action is to find as a part of the video screen which is in motion. The detection of motion can be carried out by correlating each frame to a previous frame to determine the least mean square value of the amount of change between the frames. This can be done using conventional discrete cosine transform techniques. In a particularly preferred embodiment, however, compressed video is received. Compressed video often is encoded as portions of the video that represent changes from a previous frame. Therefore, the amount of change represents the amount of movement or change. When using compressed video, the amount of change can be determined from the amount and or type of data which is received.

At 605, the amount of action and location of action are both detected. The location of the action will be used to determine the portion of the screen which will be displayed, in the event that the screen needs to be truncated. As one part of this feature, a special marker may be set, for example a specified texture difference within the video. This marker is set in the video when there is not a specified movement, but it is nonetheless an important part for the user to see. For example, if a gun is sitting on the floor in a police movie, it may be important that the user see the gun, so that the viewer knows that the policeman may reach for that gun, while viewing the video. Certainly some portions of the video would need to be shown even when there is not movement. In an embodiment, these portions of the video may be marked specified textures in the video portions. Effectively this forms an invisible “marker” in the video that may be detected and used as part of the routine. The detection of the invisible marker is shown in 610.

Based on all of these parameters, the position of maximum change, and the amount of movement are calculated at 615. The new parameters may include new optimum splits for the screen, as well as a new optimum center location for viewing on the screen. However, too much movement on the screen could prove disconcerting to the user. Accordingly, 620 limits the amount of movement which can be carried out. The limited amount of movement can be a limiting of both the split amounts between screen parts, another words the amount of movement that can be carried out, and also can be the target center. For example, in order to avoid confusion to the user, the system may only allow 5 to 10° of change per 5 seconds.

The parameters which are calculated at 615, however, may also include a wildcard parameter which allows immediate reconfiguration of the screen. The wildcard parameter for example may be used when the user actually clicks on the screen for example clicking on a portion of an interactive video or clicking on a web site or the like.

FIGS. 5A and 5B shows two different splits which may be carried out with one portion of video over the other. Another split shown in FIGS. 5B, 5C and 5D is a diagonal split in which the screen may be split according to a movable diagonal. FIG. 5C shows the 50-50 movable diagonal while FIG. 5E shows a 66/33 movable diagonal. The video displayed within the diagonal split can take up the full-screen or can represent only a box within the screen. Again, this may facilitate certain operations.

Another alternative is in the so-called separated multiple screen embodiments. Such an embodiment may be as shown in FIG. 5B where an overall image may be split between four different screens or six different screens. In this embodiment, the split may simply be carried out by removing the image from certain ones of the separated screens at certain times. For example, the interactive portions such as Internet may run in the screen 550 while the remainder of the screens show the video. Motion in the screen portion 550 may cause the Internet portion to be reduced down to a very small amount for example a split screen portion shown as 552 to obtain substantially full-screen video. In contrast, when viewing broadcast TV, detection of a commercial may cause the TV to be reduced down to the smallest possible extent, with the Internet taking up all of the rest of the screen portions. Detection of a commercial may be another wildcard event of the type noted above.

Another embodiment enables using the content identifier to recognize certain actions within a sports broadcast. For example, the content identifier can be used to identify certain actions occurring, and to readjust either the screen split or the position of viewing based on the actions occurring. For example, an instant replay may be a wildcard event which causes automatic repositioning of the screen split. In contrast, detection of actions indicating a time out in a football game may cause readjustment in the opposite direction so that the playing field where nothing is happening receives a shrinking area of display.

In another embodiment, detection of content also includes detection of specified items in the audio track. For example, one such item may be speaker independent voice recognition which can be used to detect specified words in the audio track. Certain words during a sports event may indicate that a commercial is coming can be detected and used as a screen switching event. Words of this type may include “we will return after the break”. In the alternative, other words which denote highly relevant events, can be used to detect items which a user might want to see. As in example, “base hit” might indicate that the sports event is becoming more interesting. Similarly, “time out” might denote that the sports event is becoming less interesting.

In addition to the words in the audio track, the tone of the audio track can also be analyzed. Certain tones accompanying a sports commentator getting excited, and the emotion in the voice tone can be detected using conventional techniques such as described in U.S. Pat. No. 6,151,571. The tone used can be used to aid identification of highly relevant portions of the video.

Although only a few embodiments have been disclosed in detail above, other modifications are possible. For example, while the above has described a specific type of video splitting, it should be understood that any other video splitting technique could be used. For example, these techniques could be used along with a picture-in-picture system of conventional type. For example, a user could watch two television shows at the same time. The television show with desired content can be routed to the main screen, and the volume control could also change to that television show. The television shows can switch between main and smaller screen, based on commercials. This allows the user to watch something different during the commercial and automatically switch back after the commercial. This would effectively be a priority system where the user says priority to Channel seven, second priority to Channel six. Channel seven then shows within the main screen whenever there is not a commercial, and when there is a commercial, the main screen is changed to Channel six. When the commercial is over, Channel seven returns.

Another alternative is to set the picture in picture based on different content. For example, a user could be watching a first show, with sports in the background. Whenever the sports show displays a specified item, such as an instant replay or a scorecard, this could be used as a trigger to change between the different windows.

Another embodiment adaptively sets the size of the two screens forming the picture-in-picture by using the content in a similar way to that noted above.

As an alternative to the video split, this system could also be used in side-by-side displays, with one display designated as the main display and the other designated as the slave. The content of the two displays could be switched periodically based on the content being displayed.

All such modifications, and all predictable modifications are intended to be encompassed within the following claims.

1. A system, comprising:
a first element which characterizes content of a video source, where the video source which includes information for first and second separated display parts; and
a display driver which produces outputs for said first and second display parts to be separately displayed from one another on separate portions of a display screen with said first and second display parts displayed on non-overlapping portions on said display screen, said first and second display parts being separated based on said determination of said content, where the determination is a type of content in each of said first and second display parts, and where said display driver sets a portion size of the display said first display part will occupy relative to an amount that said second display part will occupy, and where at a first time when a first content is displayed as said first display part, said first and second display parts are displayed with a first size ratio therebetween formed of first and second outer shapes; and where at a second time when a second content is displayed as said first display part, said first and second display parts are displayed with a second size ratio therebetween, and with said first and second outer shapes, where said second size ratio is different than said first size ratio.

2. A system as in claim 1, wherein said first and second display parts occupy areas on a single screen.

3. A system as in claim 1, wherein one kind of said characterized content is content which is indicative of a commercial, where said commercial as said first display part sets said first size ratio to a size that provides a smaller portion for the display part displaying the commercial, and another content as said first display part sets said second size ratio.

4. A system as in claim 1, wherein one kind of said characterized content is a content indicative of an amount of action within the scene, where a first amount of action in the scene in said first display part sets said first size ratio, and a second amount of action in the scene in said first display part sets said second size ratio, where said second amount of action in the scene is more action than the first amount of action, and said first display part occupies a greater percentage of the screen responsive to said second amount of action being detected.

5. A system as in claim 1, wherein said characterized content is a specified action that is automatically characterized.

6. A system as in claim 1, wherein said one kind of characterized content is a specified action occurring in a sports scene that is automatically characterized, which causes a larger area of said display part to be used to view said sports scene.

7. A system as in claim 1, wherein said display driver limits a rate of change of the viewing size per specified time.

8. A system, comprising:
a video characterizing system which automatically characterizes the content of video; and
a video driver, which changes the size of viewing said video based on said content which was automatically characterized, wherein said video driver limits a rate of change of the viewing size which can be carried out per specified time.

9. A system as in claim 8, wherein said video driver causes the video to be separately displayed in two parts on separate portions of a display screen with first and second display parts displayed on non-overlapping portions on said display screen, said first and second display parts being separated based on said characterizing of said content, where the characterizing is a type of content in each of said first and second display parts, and where said display driver sets a portion size of the display said first display part will occupy relative to an amount that said second display part will occupy, and where at a first time when a first content is displayed as said first display part, said first and second display parts are displayed with a first size ratio therebetween formed of first and second outer shapes; and where at a second time when a second content is displayed as said first display part, said first and second display parts are displayed with a second size ratio therebetween, and with said first and second outer shapes, where said second size ratio is different than said first size ratio.

10. A system, comprising:
a video characterizing system which automatically characterizes content of video; and
a video driver, which changes the size of viewing said video based on said content which was automatically characterized without changing a form of an outer shape of said video, further comprising identifying a category of content, and determining from said category whether an amount of change of the viewing size which can be carried out in a specified time should be limited, and if so, limiting an amount of change which can be carried out in any specified time, and if not, allowing said amount of change to be carried out without said limiting.

11. A system as in claim 8, wherein said characterizing comprises detecting commercials and reducing a size of a screen portion that is associated with displaying said commercials.

12. A system as in claim 7, wherein said characterizing comprises detecting action within a scene and increasing a size of a screen portion that is associated with displaying said action.

13. A system as in claim 7, wherein said characterizing comprises detecting a specified action within a scene and increasing a size of a screen portion that is associated with displaying said action.

14. A method, comprising:
operating a video system which includes first and second viewing functions which includes a main viewing part and an auxiliary viewing part, smaller than said main viewing part;
determining content to go into said main viewing part and said auxiliary viewing part;
changing sizes of said main viewing part and said auxiliary viewing part; and
limiting a rate of change of the viewing size which can be carried out per specified time.

15. A method as in claim 14 wherein said determining comprises detecting commercials in a first video within the main viewing part, and changing said first video to the auxiliary viewing part responsive to said determining a commercial.

16. A method as in claim 14, wherein said first and second viewing functions include a picture in picture function with said main viewing part being the overall view, and said auxiliary viewing part being a miniature view within the main viewing part.

17. A method as in claim 14, wherein said determining content comprises automatically detecting action within the main viewing part.

18. A method as in claim 14, wherein said determining content comprises automatically detecting a commercial within the main viewing part.

19. A method as in claim 14, wherein said determining content comprises detecting specified words within an audio track.

20. A method as in claim 16, wherein said determining content automatically determines the content, and further comprising adaptively sizing elements of the picture in picture based on said determining content.
